(19) United States
(12) Patent Application Publication
(10) Pub. No.: US 2023/0222990 A1
(43) Pub. Date: Jul. 13, 2023

(54) SYSTEM AND METHOD FOR OUTPUTTING AUGMENTED REALITY CONTENTS THROUGH WEARABLE DEVICE AND MOBILE DEVICE

(71) Applicant: Samsung Electronics Co., Ltd., Suwon-si (KR)

(72) Inventors: Wooju YUN, Suwon-si (KR); Chanmin PARK, Suwon-si (KR); Jungjik LEE, Suwon-si (KR)

(21) Appl. No.: 18/077,597

(22) Filed: Dec. 8, 2022

Related U.S. Application Data
(63) Continuation of application No. PCT/KR2022/017327, filed on Nov. 7, 2022.

(30) Foreign Application Priority Data
Jan. 7, 2022 (KR) 10-2022-0002590
Feb. 25, 2022 (KR) 10-2022-0024757

(51) Int. Cl. G09G 5/00; G02B 27/00; G02B 27/01; H04B 17/318

(52) U.S. Cl. CPC G09G 5/005; G02B 27/0093; G02B 27/0179; G02B 27/0101; G02B 27/017; H04B 17/318; G09G 2350/00; G02B 2027/0187; G02B 2027/0178

(57) ABSTRACT

A wearable device is provided. The wearable device includes space information including at least one of a location of the wearable device or a direction in which the wearable device is oriented, and transmit the space information to a mobile device, in response to satisfaction of a designated condition by a state in which first image data is received from the mobile device, display, on the display, the first image data including a first object identified based on the space information, receive modeling data associated with the first object from the mobile device, and in response to non-satisfaction of the designated condition by a state in which the first image data is received from the mobile device, generate second image data, based on the modeling data, and display the second image data on the display, the second image data including a first simplified object corresponding to the first object.

### CROSS-REFERENCE TO RELATED APPLICATION(S)

This application is a continuation application, claiming priority under § 365(c), of an International application No. PCT/KR2022/017327, filed on Nov. 7, 2022, which is based on and claims the benefit of a Korean patent application number 10-2022-0002590, filed on Jan. 7, 2022, in the Korean Intellectual Property Office, and of a Korean patent application number 10-2022-0024757, filed on Feb. 25, 2022, in the Korean Intellectual Property Office, the disclosure of each of which is incorporated by reference herein in its entirety.

### TECHNICAL FIELD

The disclosure relates to a technology of outputting an augmented reality content by using a wearable device and a mobile device.

### BACKGROUND ART

Augmented reality (AR) involves a technology of combining a virtual object or information with an actually existing environment so that the virtual object or information appears to exist in a real environment. For example, augmented reality may be implemented via a head-mounted display (HMD) that is worn on a user's head to directly present an image in front of the eyes of the user.

Initial markets for augmented reality have been established mainly in the entertainment industries including gaming and imaging. However, according to recent acceleration of mutual growth with relevant technologies and convergence between industries, the application of augmented reality to various industries including healthcare, education, shopping, and manufacturing has been realized. Accordingly, augmented reality contents are being provided to users in various environments by use of various wearable devices such as augmented reality (AR) glasses.

The above information is presented as background information only to assist with an understanding of the disclosure. No determination has been made, and no assertion is made, as to whether any of the above might be applicable as prior art with regard to the disclosure.

### DISCLOSURE

### Technical Problem

A wearable device such as augmented reality glasses may receive image data including an augmented reality content from a mobile device through wired/wireless communication, and display the received image data on a display. However, when a wired or wireless communication between the mobile device and the wearable device becomes unstable while the wearable device displays the image data and provides the augmented reality content, the wearable device has difficulty receiving the image data from the mobile device, and thus may have difficulty stably displaying the augmented reality content.

Aspects of the disclosure are to address at least the above-mentioned problems and/or disadvantages and to provide at least the advantages described below. Accordingly, an aspect of the disclosure is to provide a technology of outputting an augmented reality content by using a wearable device and a mobile device.

Additional aspects will be set forth in part in the description which follows and, in part, will be apparent from the description, or may be learned by practice of the presented embodiments.

### Technical Solution

In accordance with an aspect of the disclosure, a wearable device is provided. The wearable device includes a communication circuit configured to transmit or receive data to or from a mobile device, a sensor, a display, and at least one processor electrically connected to the communication circuit, the sensor, and the display. The at least one processor may be configured to obtain, via the sensor, space information including at least one of location information corresponding to a location of the wearable device or direction information corresponding to a direction in which the wearable device is oriented, and transmit the space information to the mobile device via the communication circuit, in response to satisfaction of a designated condition by a state in which first image data is received from the mobile device via the communication circuit, display, on the display, the first image data including a first object identified based on the space information, receive modeling data associated with the first object from the mobile device via the communication circuit, and in response to non-satisfaction of the designated condition by a state in which the first image data is received from the mobile device via the communication circuit, generate second image data, based on the modeling data, and display the second image data on the display, the second image data including a first simplified object corresponding to the first object.

In accordance with another aspect of the disclosure, a mobile device is provided. The mobile device includes a communication circuit configured to transmit or receive data to or from a wearable device, and at least one processor electrically connected to the communication circuit. The at least one processor may be configured to receive, from the wearable device via the communication circuit, space information including at least one of location information corresponding to a location of the wearable device or direction information corresponding to a direction in which the wearable device is oriented, generate first image data including a first object identified based on the space information among virtual objects in a virtual space, and transmit the first image data via the communication circuit to allow the wearable device to display the first image data, and transmit modeling data associated with the first object to the wearable device via the communication circuit, wherein the modeling data is used to allow the wearable device to display a first simplified object corresponding to the first object.

### Advantageous Effects

According to various embodiments disclosed herein, even when wired or wireless communication between a wearable device and a mobile device becomes unstable, the wearable device may generate, by itself, image data including an augmented reality content. Therefore, even in a situation where a wearable device is unable to stably receive image data from a mobile device, the wearable device is capable of generating image data and providing an augmented reality content to a user.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates an example of an appearance of a wearable device according to an embodiment of the disclosure;

FIG. 3 is a block diagram illustrating a hardware configuration of a wearable device according to an embodiment of the disclosure;

FIG. 4 is a block diagram illustrating a hardware configuration of a mobile device according to an embodiment of the disclosure;

FIG. 5 illustrates an operation of transmitting or receiving data between a software module included in a wearable device and a software module included in a mobile device according to an embodiment of the disclosure;

FIG. 6 is a flowchart illustrating an operation in which a wearable device and a mobile device transmits or receives data therebetween to provide image data including an augmented reality content to a user according to an embodiment of the disclosure;

FIG. 7 is a flowchart illustrating an operation for displaying first image data or second image data by a wearable device according to an embodiment of the disclosure;

FIG. 8 is a flowchart illustrating an operation of a wearable device in a case where the wearable device has received first modeling data and second modeling data having different data amounts in relation to a first object according to an embodiment of the disclosure;

FIG. 9 is a flowchart illustrating an operation for generating second image data by further using space information by a wearable device according to an embodiment of the disclosure;

FIG. 10 is a flowchart illustrating an operation in which a mobile device transmits first image data and modeling data associated with a first object, based on space information received from a wearable device according to an embodiment of the disclosure;

FIG. 11 is a flowchart illustrating an operation in which a mobile device selects and transmits, to a wearable device, one modeling data among first modeling data and second modeling data that have different data amounts and are associated with a first object according to an embodiment of the disclosure;

FIG. 12 is a flowchart illustrating an operation of considering the priorities of multiple objects by a mobile device according to an embodiment of the disclosure; and

FIG. 13 illustrates an example of first image data and an example of second image data displayed by a wearable device according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

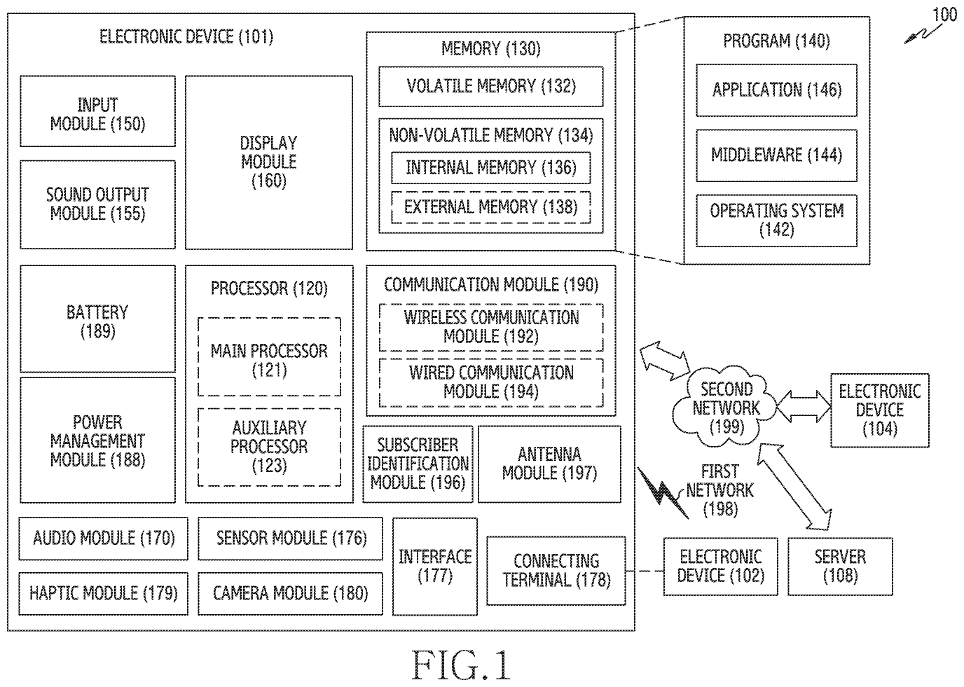

FIG. 1 is a block diagram illustrating an electronic device 101 in a network environment 100 according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

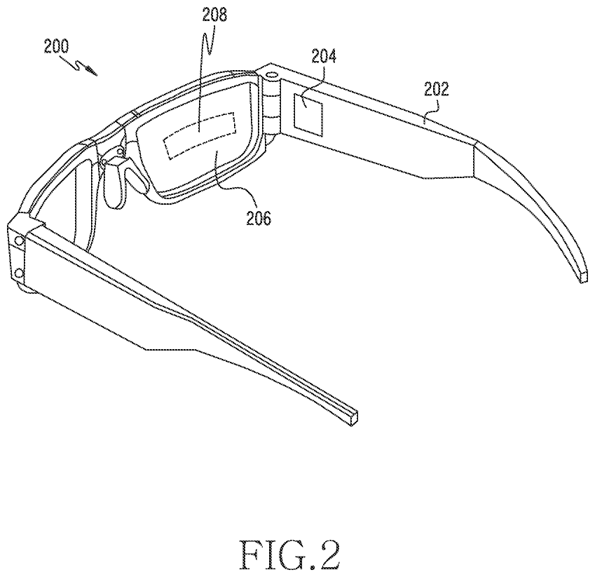

FIG. 2 illustrates an example of an appearance of a wearable device according to an embodiment of the disclosure.

According to an embodiment, a wearable device 200 may correspond to an electronic device 104 in FIG. 1. Referring to FIG. 2, a wearable device 200 may be augmented reality glasses having a shape of glasses, and may include a temple 202 and a transparent member 206.

According to another embodiment, a projector 204 and a prism (not illustrated) may be arranged at the temple 202 of the wearable device 200. In addition, a waveguide 208 may be disposed at least a partial area of the transparent member 206. The waveguide 208 may be called a screen display unit.

According to yet another embodiment, the transparent member 206 of the wearable device 200 may be made of a transparent or semi-transparent material. The transparent member 206 may be made of a glass plate, a plastic plate, or polymer. A user wearing the wearable device 200 may identify an actual environment together with image data output via the transparent member 206. Through this operation, the wearable device 200 may implement augmented reality (AR) for a real environment.

In an embodiment, the waveguide 208 may transfer light output from the projector 204, to a user's eye. In another embodiment, the waveguide 208 may be manufactured of glass, plastic, or polymer, and may include a nano pattern (e.g., a grating structure having a polygonal shape or a curved surface shape) disposed on one inner or outer surface of the waveguide 208. In yet another embodiment, light incident into one end of a waveguide tube may be provided to a user by being propagated in the waveguide 208 by the nano pattern. The waveguide 208 configured by a freeform prism may provide the light to a user via a reflective mirror. The waveguide 208 may include at least one of at least one diffractive element (e.g., a diffractive optical element (DOE) or a holographic optical element (HOE)) or a reflective element (e.g., a reflective mirror). The waveguide 208, for example, may guide light emitted from the projector 204, to a user's eye by using the at least one diffractive element and/or the reflective element.

In an embodiment, the projector 204 may generate/output light including image data, and the light may be transferred to a user's eye via the waveguide 208. In another embodiment, the projector 204 may emit a beam including image data toward a prism, and light refracted from the prism may be displayed on the transparent member 206. In the disclosure, an image or image data may be understood as corresponding to a screen displayed on a display. In addition, in the disclosure, the wearable device 200 displaying or outputting image data may include at least one of the projector 204 outputting light including image data or light output from the projector 204, being provided to a user's eye via the transparent member 206 or the waveguide 208.

In an embodiment, in relation to FIG. 2, only the temple 202, the projector 204, the transparent member 206, and the waveguide 208 arranged in one direction (e.g., the right) of the wearable device 200 have been described, but the description for the temple 202, the projector 204, the transparent member 206, and the waveguide 208 may also be applied to a temple, a projector, a transparent member, and a waveguide in a different direction (e.g., the left). In addition, the wearable device 200 illustrated in FIG. 2 is one example, and embodiments of the disclosure may be applied to various types of head-mounted displays (HMDs) including a configuration enabling output of image data.

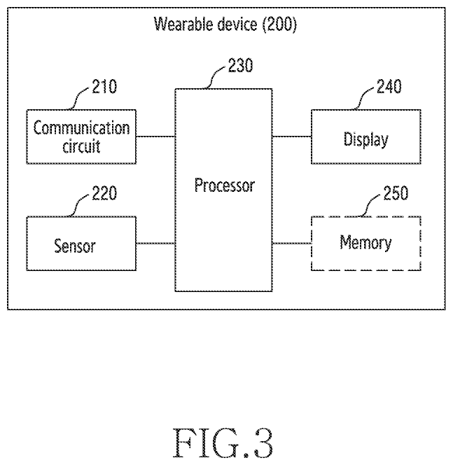

FIG. 3 is a block diagram illustrating a hardware configuration of a wearable device according to an embodiment of the disclosure.

Referring to FIG. 3, a wearable device 200 may include a communication circuit 210, a sensor 220, a processor 230, and a display 240. According to an embodiment, the display 240 may include a transparent member 206 illustrated in FIG. 2 or may be included in the transparent member 206. In addition, the display 240 may also include a projector 204 illustrated in FIG. 2. According to an embodiment, the wearable device 200 may further include a memory 250 connected to the processor 230.

According to another embodiment, the communication circuit 210 may transmit or receive data to or from a mobile device (e.g., the electronic device 101 in FIG. 1). The communication circuit 210 may be a wireless communication circuit. The wearable device 200 may access a wireless network via the communication circuit 210, and exchange data with an external electronic device (e.g., a mobile device). In an example, the communication circuit 210 may support at least one of Bluetooth, Wi-Fi, or global positioning system (GPS). As another example, the communication circuit 210 may also be a wired communication circuit. In an embodiment, the wearable device 200 may also exchange data with an external electronic device (e.g., a mobile device) through a communication line.

In another embodiment, the sensor 220 may include at least one of an acceleration sensor, a gyro sensor, a geomagnetic sensor, or an image sensor. For example, the acceleration sensor may measure accelerations applied in three axes (e.g., x-axis, y-axis, or z-axis) of the wearable device 200. The processor 230 may measure, estimate, and/or detect force being applied to the wearable device 200, by using the acceleration measured by the acceleration sensor. However, the above sensors are examples, and the sensor 220 may be configured by various types of sensors capable of obtaining information related to the wearable device 200.

In still another embodiment, the sensor 220 may obtain space information related to the wearable device 200. According to an embodiment, the processor 230 may obtain location information corresponding to the location of the wearable device 200 by using the sensor 220. In an example, the processor 230 may obtain location information corresponding to the location of the wearable device 200 by using the GPS. As another example, the processor 230 may obtain coordinate information of a point at which the wearable device 200 is located, with respect to the origin of a virtual space by using the sensor 220. According to another embodiment, the processor 230 may obtain direction information corresponding to a direction in which the wearable device 200 is oriented, by using the sensor 220. The direction in which the wearable device 200 is oriented may correspond to a direction in which a user looks straight up while wearing the wearable device 200. According to yet another embodiment, the processor 230 may obtain space information including at least one of the location information or the direction information. The space information may further include information on a speed at which the wearable device 200 rotates, and which is measured by the acceleration sensor or the gyro sensor. As another example, the space information may further include information on a space map for a surrounding environment of the wearable device 200, which is obtained by the image sensor and performing simultaneous localization and mapping (SLAM).

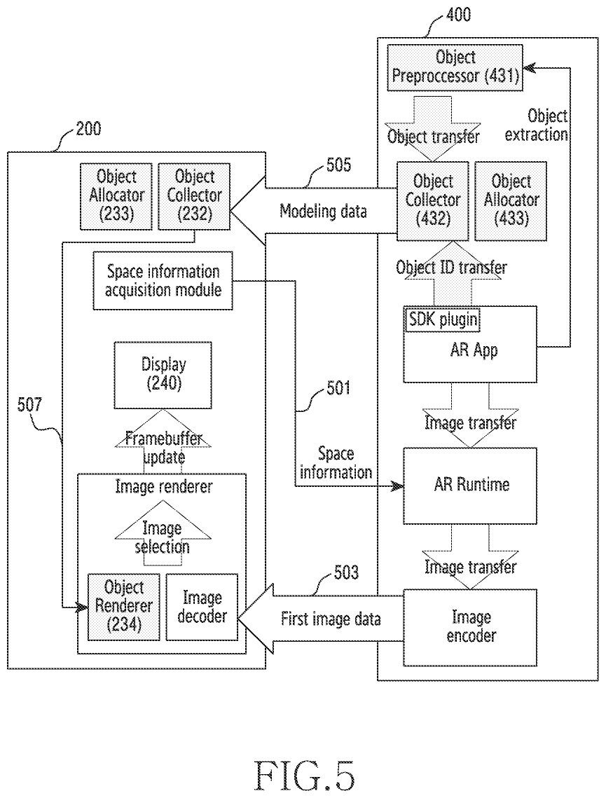

In an embodiment, the processor 230 may be understood as including at least one processor. For example, the processor 230 may include at least one of an application processor (AP), an image signal processor (ISP), and a communication processor (CP). In another embodiment, the processor 230 may include at least one software module. The software module will be described later in relation to FIG. 5.

In an embodiment, the display 240 may display image data including an augmented reality content. In another embodiment, the processor 230 may provide image data to a user via the display 240. In an example, the processor 230 may display, on the display 240, first image data received from a mobile device via the communication circuit 210. As another example, the processor 230 may generate second image data, based on modeling data stored in the memory 250, and display the generated second image data on the display 240.

According to an embodiment, the memory 250 may store various types of programming languages or instructions performed by the processor 230. For example, the processor 230 may execute a code written by a programming language stored in the memory 250, to execute an application and control various types of hardware. In addition, the processor 230 may execute instructions stored in the memory 250, to support the display 240 to display image data received from an external electronic device (e.g., a mobile device). According to another embodiment, the processor 230 may store, in the memory 250, modeling data received via the communication circuit 210.

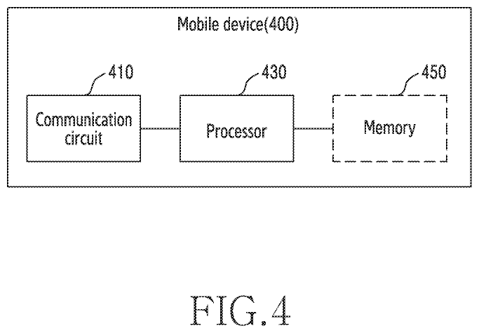

FIG. 4 is a block diagram illustrating a hardware configuration of a mobile device according to an embodiment of the disclosure.

Referring to FIG. 4, a mobile device 400 may include a communication circuit 410 and a processor 430. According to an embodiment, the mobile device 400 may further include a memory 450 connected to the processor 430. According to another embodiment, the mobile device 400 may correspond to an electronic device 101 in FIG. 1, the communication circuit 410 may correspond to a communication module 190 in FIG. 1, the processor 430 may correspond to a processor 120 in FIG. 1, and the memory 450 may correspond to a memory 130 in FIG. 1.

According to still another embodiment, the communication circuit 410 may transmit or receive data to or from the wearable device 200. The communication circuit 410 may be a wireless communication circuit. The mobile device 400 may access a wireless network via the communication circuit 410, and exchange data with the wearable device 200. In an example, the communication circuit 410 may support at least one of Bluetooth, Wi-Fi, or GPS. As another example, the communication circuit 410 may also be a wired communication circuit. In an embodiment, the mobile device 400 may also exchange data with an external electronic device (e.g., the wearable device 200) through a communication line.

According to an embodiment, the processor 430 may be understood as including at least one processor. In an embodiment, the processor 430 may include at least one of an application processor (AP), an image signal processor (ISP), and a communication processor (CP). In another embodiment, the processor 430 may include at least one software module. The software module will be described later in relation to FIG. 5.

According to an embodiment, the memory 450 may store various types of programming languages or instructions by the processor 430. For example, the processor 430 may execute a code written by a programming language stored in the memory 450, to execute an application and control various types of hardware. According to another embodiment, the memory 450 may store at least one application and virtual objects associated with the at least one application.

FIG. 5 illustrates an operation of transmitting or receiving data between a software module included in a wearable device and a software module included in a mobile device according to an embodiment of the disclosure.

Referring to FIG. 5, a wearable device 200 may use a hardware and/or software module to support an augmented reality function. For example, a processor 230 may execute instructions stored in a memory 250 to drive a space information acquisition module, an object collector 232, an object allocator 233, an object renderer 234, an image decoder, and an image renderer so as to execute an application associated with the augmented reality function.

Referring to FIG. 5, the mobile device 400 may use a hardware and/or software module to support an augmented reality function. The processor 430 may execute instructions stored in the memory 450 to drive an object preprocessor 431, an object collector 432, an object allocator 433, a runtime, and an image encoder so as to execute an augmented reality application. In the disclosure, the augmented reality application may indicate an application providing an augmented reality function. The application providing the augmented reality function may include a navigation application showing the way to a user through augmented reality, or a game application using augmented reality. In addition, an augmented reality application may include applications capable of providing various information (e.g., advertisements, social networking service (SNS) information, the importance level of a surrounding object, and the risk level of a surrounding object, and the like) to a user through augmented reality.

According to an embodiment, a software module different from that illustrated in FIG. 5 may be implemented. At least two of the software modules illustrated in FIG. 5 may be integrated into one module, or one module may be divided into two or more modules. For example, some of the software modules illustrated in FIG. 5 may be omitted.

According to another embodiment, in operation 501, the space information acquisition module of the wearable device 200 may transmit space information to the mobile device 400. For example, the space information acquisition module may obtain space information described with reference to FIG. 3 from the sensor 220. In addition, the space information acquisition module may provide space information to the mobile device 400 via the communication circuit 210.

In an embodiment, the mobile device 400 may execute an augmented reality application. The augmented reality application may provide an image (e.g., first image data) including an augmented reality content to the runtime. In another embodiment, the runtime may obtain an image (e.g., first image data) from the augmented reality application, and obtain space information from the wearable device 200. In addition, the runtime may provide the image (e.g., first image data) to the image encoder.

According to an embodiment, the image encoder of the mobile device 400 may obtain an image (e.g., compressed first image data) compressed by encoding an image obtained from the runtime. According to another embodiment, in operation 503, the mobile device 400 may transmit an image compressed via the image encoder, to the wearable device 200. For example, the mobile device 400 may transmit a compressed image to the wearable device 200 via the communication circuit 410.

According to yet another embodiment, the wearable device 200 may receive the compressed image (e.g., compressed first image data) from the mobile device 400. The image decoder may decode the compressed image.

According to an embodiment, the image renderer of the wearable device 200 may select at least a part of an image (e.g., first image data) received from the mobile device 400. According to another embodiment, the image renderer may update a framebuffer of the display 240, based on an image (e.g., first image data) received from the mobile device 400. The wearable device 200 may control the display 240 to display an image (e.g., first image data) received from the mobile device 400.

The mobile device 400 may render and then transmit, to the wearable device 200, first image data to be displayed on the wearable device 200, and the wearable device 200 may receive and display, on the display 240, the first image data generated in the mobile device 400.

However, according to the disclosure, the mobile device 400 may transmit modeling data associated with a virtual object to the wearable device 200 as well as first image data. The wearable device 200 may generate second image data including an augmented reality content, based on modeling data obtained from the mobile device 400. The wearable device 200 may receive and display first image data generated in the mobile device 400, or may generate second image data, based on modeling data by itself and display same. Therefore, even in a situation where the wearable device 200 has difficulty receiving first image data from the mobile device 400 as wired or wireless communication between the mobile device 400 and the wearable device 200 becomes unstable, the wearable device 200 may render and display, on the display 240, second image data. Even in a situation where a wired communication line between the mobile device 400 and the wearable device 200 is disconnected, normal access to a wireless communication network becomes difficult, or a communication state becomes unstable according to the lack of the remaining battery power of at least one of the mobile device 400 or the wearable device 200, the wearable device 200 may render and display, on the display 240, second image data.

In an embodiment, the mobile device 400 may include the object preprocessor 431, the object collector 432, and the object allocator 433 for acquisition and transmission of the modeling data. In addition, the wearable device 200 may include the object collector 232, the object allocator 233, and the object renderer 234 for reception of the modeling data and generation of second image data.

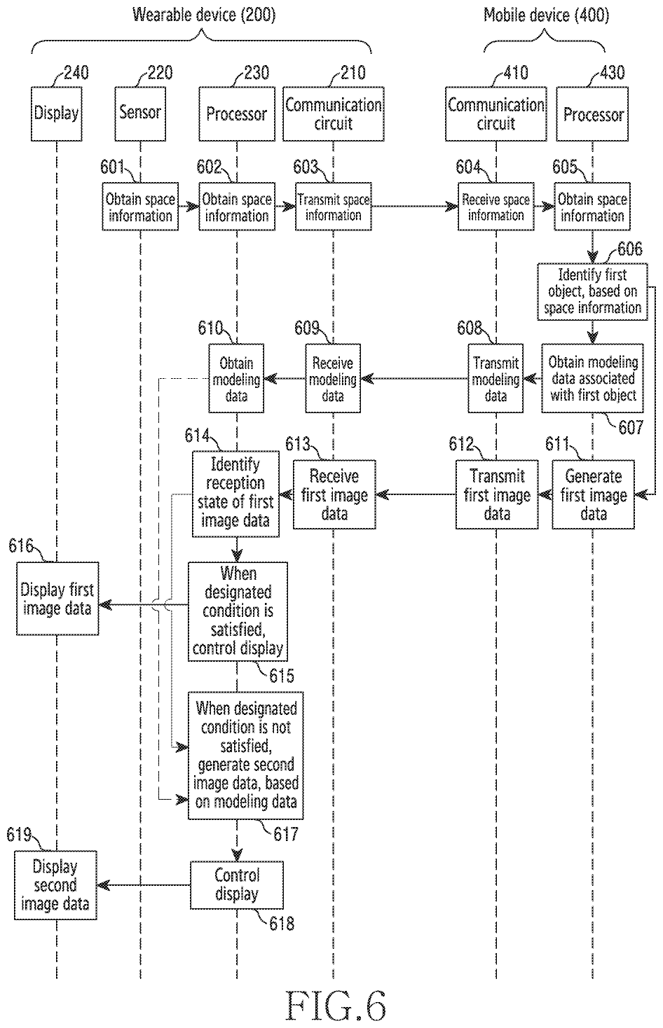

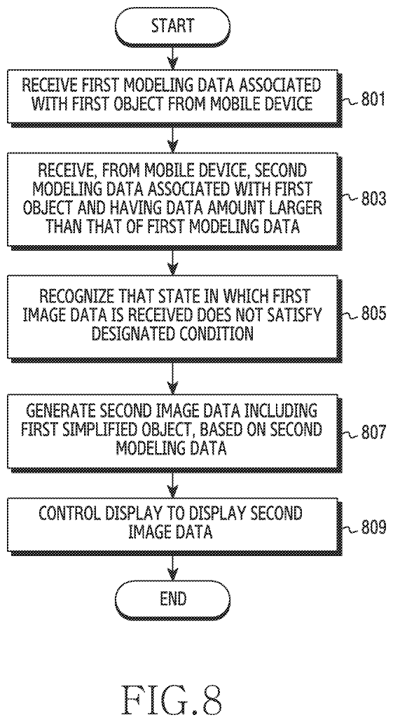

In another embodiment, the mobile device 400 may provide at least some objects among virtual objects associated with an augmented reality application to the object preprocessor 431. For example, the mobile device 400 may extract and provide, to the object preprocessor 431, at least some objects among virtual objects associated with an augmented reality application. In the disclosure, the object may be understood as meaning a virtual object. In still another embodiment, the object preprocessor 431 may obtain modeling data associated with an object obtained from an augmented reality application, based on the object. The modeling data will be described later with reference to FIGS. 6 and 8.

The mobile device 400 may install an augmented reality application, and then provide virtual objects used to execute the augmented reality application, to the object preprocessor 431. The object preprocessor 431 may extract and store modeling data for each of the obtained virtual objects.

As another example, the mobile device 400 may determine that at least one virtual object is required for an augmented reality function, while an augmented reality application is executed. The mobile device 400 may provide, to the object preprocessor 431, at least one virtual object determined to be required while an augmented reality application is executed. The object preprocessor 431 may also extract and store modeling data for the at least one virtual object while an augmented reality application is executed.

According to an embodiment, the object preprocessor 431 may transfer the modeling data to the object collector 432. The object collector 432 may select at least a part of modeling data obtained from the object preprocessor 431. In an example, the object collector 432 may use space information received from the wearable device 200 to select modeling data corresponding to at least some virtual objects among modeling data corresponding to different virtual objects. As another example, the object collector 432 may receive an object ID from an augmented reality application, and select at least a part of the modeling data, based on the received object ID.

According to another embodiment, the object allocator 433 may determine whether to transmit modeling data to the wearable device 200 by considering a storage space of the wearable device 200. According to yet another embodiment, the object allocator 433 may manage buffers for virtual objects, and manage a storage space of the wearable device 200 in relation to modeling data.

In an embodiment, the mobile device 400 may use the object collector 432 and the object allocator 433 to determine modeling data to be transmitted to the wearable device 200. In operation 505, the mobile device 400 may transmit the determined modeling data to the wearable device 200.

In another embodiment, the wearable device 200 may receive modeling data from the mobile device 400. The wearable device 200 may use the object collector 232 and the object allocator 233 to collect and arrange the modeling data.

In still another embodiment, in operation 507, the wearable device 200 may transfer modeling data from the object collector 232 to the object renderer 234. When it is determined that a communication state with the mobile device 400 is unstable, the wearable device 200 may provide modeling data to the object renderer 234. As another example, when it is determined that first image data is difficult to be displayed due to a low speed at which the first image data is received from the mobile device 400, the wearable device 200 may provide modeling data to the object renderer 234.

According to an embodiment, the object collector 232 may select modeling data corresponding to at least some virtual objects among modeling data corresponding to different virtual objects, based on space information. For example, the object collector 232 may transfer at least a part of modeling data received from the mobile device 400 to the object renderer 234.

According to another embodiment, the object renderer 234 may generate second image data including a virtual object, based on modeling data obtained from the object collector 232. A virtual object included in second image data generated by the object renderer 234 may have a quality lower than that of a virtual object included in first image data generated by the mobile device 400. A virtual object included in first image data and a virtual object included in second image data will be described later with reference to FIG. 6.

According to yet another embodiment, the wearable device 200 may use the object collector 232, the object allocator 233, and the object renderer 234 to generate second image data, and thus even in a situation when a communication state with the mobile device 400 is unstable, may provide an augmented reality content to a user via the display 240.

In an embodiment, in relation to FIG. 5, a software module of the wearable device 200 or a software module included in the module device 400 has been described to perform operations of the disclosure. However, the operations may also be understood as being performed by the processor 230 of the wearable device 200 or the processor 430 of the mobile device 400. With reference to FIGS. 6 to 13, embodiments of the disclosure will be described based on operations performed by the processor 230 of the wearable device 200 or the processor 430 of the mobile device 400.

FIG. 6 is a flowchart illustrating an operation in which a wearable device and a mobile device transmit or receive data therebetween to provide image data including an augmented reality content to a user according to an embodiment of the disclosure. Operations illustrated in FIG. 6 may be understood as being performed by a wearable device 200 or a mobile device 400.

In an embodiment, in operation 601, the sensor 220 of the wearable device 200 may obtain space information. In another embodiment, in operation 602, the processor 230 may obtain the space information by using the sensor 220. For example, the space information may include location information corresponding to the location of the wearable device 200. Alternatively, the space information may include location information for a location in a virtual space, corresponding to the location of the wearable device 200. As another example, the space information may include direction information corresponding to a direction in which the wearable device 200 is oriented. In an embodiment, the space information may include information on at least one of a direction in which or a speed at which the wearable device 200 rotates. In another embodiment, the space information may further include a space map for a surrounding environment of the wearable device 200, which is obtained through SLAM.

According to an embodiment, in operation 603, the processor 230 may transmit the space information to the mobile device 400 via the communication circuit 210. According to another embodiment, in operation 604, the communication circuit 410 of the mobile device 400 may receive the space information by using wireless communication with the communication circuit 210 of the wearable device 200. According to still another embodiment, in operation 605, the processor 430 may obtain the space information via the communication circuit 410.

In an embodiment, in operation 606, the processor 430 may identify a first object, based on the space information.

In another embodiment, the memory 450 may store at least one application and virtual objects associated with the at least one application. For example, the at least one application may include a navigation application, a game application, an advertisement providing application, and an SNS application. The at least one application may be an application providing an augmented reality function. In addition, for example, the virtual object may include an augmented reality content (e.g., an arrow for showing the way, information on surrounding stores, an icon used for game progress, billboards, a different user's SNS information) provided to a user while at least one application is executed. According to yet another embodiment, virtual objects may be located at particular points in a virtual space. In case that the mobile device 400 executes a navigation application, the processor 430 may identify that a first object among virtual objects associated with the navigation application is located at a first point that is a particular point in a virtual space.

In an embodiment, the processor 430 may select at least one object among virtual objects stored in the memory 450, based on space information. In another embodiment, the processor 430 may select at least one object, based on whether the distance between the wearable device 200 and virtual objects in a virtual space is smaller than a first distance (e.g., 1 m). For example, when the location of the wearable device 200 is changed according to a movement of a user, the mobile device 400 may identify the location of, in a virtual space, of the wearable device 200 by using location information. The processor 430 may identify the location of, in a virtual space, of the wearable device 200, and the location of, in the virtual space, of a first object among virtual objects. In case that the wearable device 200 moves closer to the first object (e.g., the distance between the wearable device 200 and the first object becomes smaller than a first distance), the processor 430 may select the first object among virtual objects. In the disclosure, the first object may be included in a virtual object.

According to an embodiment, in operation 607, the processor 430 may obtain modeling data associated with the first object. According to another embodiment, the modeling data may be data corresponding to a part of the shape of the first object. When the first object is an arrow object configured by a curved surface, the modeling data may be data defining the shape of an arrow object, the curved surface of which is at least partially replaced with a flat surface.

In an embodiment, the processor 430 may generate modeling data associated with the first object in response to identification of the first object in operation 606, or may also retrieve modeling data stored in the memory in response to identification of the first object.

According to an embodiment, in operation 608, the processor 430 may transmit the modeling data to the wearable device 200 via the communication circuit 410. According to another embodiment, in operation 609, the wearable device 200 may receive the modeling data via the communication circuit 210. According to yet another embodiment, in operation 610, the processor 230 may obtain the modeling data from the communication circuit 210. For example, the processor 230 may store the modeling data received from the mobile device 400 in the memory 250.

According to an embodiment, in operation 611, the processor 430 may generate first image data including the first object. For example, the processor 430 may render the first image data to be displayed on the wearable device 200. According to another embodiment, the processor 430 may generate the first image data by using the space information. For example, the processor 430 may determine, based on the space information, a direction in which the wearable device 200 is oriented, identify a virtual object to be displayed on the wearable device 200 according to the direction in which the wearable device 200 is oriented, and generate the first image data including the identified virtual object. According to still another embodiment, in operation 612, the mobile device 400 may transmit the first image data to the wearable device 200 via the communication circuit 410.

In an embodiment, in operation 613, the wearable device 200 may receive the first image data from the mobile device 400. In another embodiment, in operation 614, the processor 230 may identify a reception state of the first image data. For example, the processor may identify whether a speed at which the first image data is received is equal to or greater than a designated speed. As another example, the processor may also identify a connection state of wireless communication between the wearable device 200 and the mobile device 400. In still another embodiment, the processor 230 may identify whether the reception state of the first image data satisfies a designated condition. The designated condition may include at least one of a condition that the wireless communication strength between the mobile device 400 and the wearable device 200 is equal to or greater than a designated strength, or a condition that a speed at which first image data is received is equal to or greater than a designated speed.

In an embodiment, in operation 615, in case that a state in which the first image data is received from the mobile device 400 satisfies a designated condition, the processor 230 may control the display 240 to display the first image data. In another embodiment, in case that the first image data is normally transmitted from the mobile device 400, the processor 230 may display the first image data received from the mobile device 400. In yet another embodiment, in operation 616, the display 240 may display the first image data. In case that a state in which the first image data is received satisfies a designated condition, the wearable device 200 may not use the modeling data obtained in operation 610.

According to an embodiment, in operation 617, in case that a state in which the first image data is received does not satisfy a designated condition, the processor 230 may generate second image data, based on the modeling data received in operation 610. In case that the first image data is not normally transmitted from the mobile device 400, the processor 230 may render the second image data, based on the modeling data by itself. According to another embodiment, in operation 618, the processor 230 may control the display 240 to display the generated second image data. According to yet another embodiment, in operation 619, the display 240 may display the second image data.

The first image data may include the first object, and the second image data may include a first simplified object corresponding to the first object. The shape of the first simplified object may correspond to a part of the shape of the first object. Alternatively, the first simplified object may have a shape at least partially corresponding to the first object and having a reduced quality compared to the first object. The first object may be an arrow object configured by a curved surface, and the first simplified object may be an arrow object, the curved surface of which is at least partially replaced with a flat surface. As another example, the first simplified object may be an arrow object configured by a line without a surface. The wearable device 200 generates the second image data, based on the modeling data received from the mobile device 400, and thus the first simplified object included in the second image data may have a shape different from that of the first object included in the first image data.

According to embodiments of the disclosure, in case that the first image data is stably received from the mobile device 400, the wearable device 200 may display the first image data on the display 240, and even in case that first image data is not stably received from the mobile device 400, the wearable device 200 may render the second image data and display same on the display 240. Even when wireless communication between the wearable device 200 and the mobile device 400 becomes unstable, the wearable device 200 may generate, by itself, image data (e.g., second image data) including an augmented reality content. Therefore, even in a situation where the wearable device 200 is unable to stably receive image data (e.g., first image data) from the mobile device 400, the wearable device 200 may generate image data to provide an augmented reality content to a user. In addition, the wearable device 200 may also provide a seamless augmented reality content to a user.

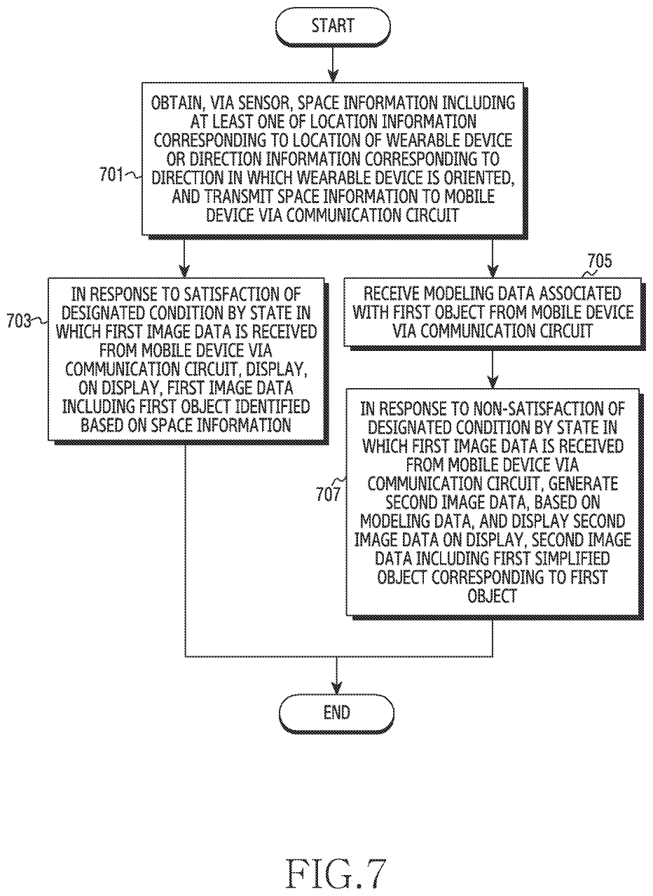

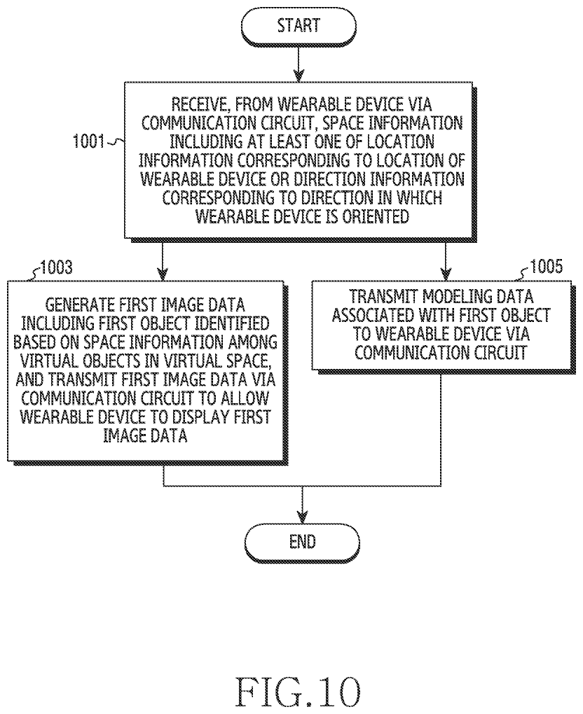

Reference to FIG. 6, a system including a wearable device 200 and a mobile device 400 has been described, with reference to FIGS. 7 to 9, an operation of a wearable device 200 in the system will be further described, and with reference to FIGS. 10 to 12, an operation of a mobile device 400 in a system will be further described.

FIG. 7 is a flowchart illustrating an operation for displaying first image data or second image data by a wearable device according to an embodiment of the disclosure. Operations illustrated in FIG. 7 may be understood as being performed by a wearable device 200 or a processor 230 included in the wearable device 200.

According to an embodiment, in operation 701, the processor 230 may obtain, via the sensor 220, space information including at least one of location information corresponding to the location of the wearable device 200 or direction information corresponding to a direction in which the wearable device 200 is oriented. The location information may indicate a location in a virtual space, corresponding to the location of the wearable device 200. The processor 230 may transmit the space information to the mobile device 400 via the communication circuit 210. Operation 701 may correspond to operations 601 to 603 in FIG. 6.

According to another embodiment, in operation 703, in response to satisfaction of a designated condition by a state in which first image data is received from the mobile device 400 via the communication circuit 210, the processor 230 may display, on the display 240, first image data including a first object identified based on the space information. Operation 703 may correspond to operations 613, 614, 615, and 616 in FIG. 6.

According to an embodiment, in operation 705, the processor 230 may receive modeling data associated with the first object from the mobile device 400 via the communication circuit 210. Operation 705 may correspond to operations 609 and 610 in FIG. 6.

According to yet another embodiment, in operation 707, in response to non-satisfaction of the designated condition by a state in which the first image data is received from the mobile device 400 via the communication circuit 210, the processor 230 may generate second image data, based on the modeling data. The processor 230 may display the second image data on the display 240. The second image data may include a first simplified object corresponding to the first object. Operation 707 may correspond to operations 614, 617, 618, and 619 in FIG. 6.

FIG. 8 is a flowchart illustrating an operation of a wearable device in a case where the wearable device has received first modeling data and second modeling data having different data amounts in relation to a first object according to an embodiment of the disclosure. Operations illustrated in FIG. 8 may be performed by a wearable device 200 or a processor 230 included in the wearable device 200.

According to an embodiment, in operation 801, the processor 230 may receive first modeling data associated with a first object from the mobile device 400. According to another embodiment, in operation 803, the processor 230 may receive second modeling data associated with the first object from the mobile device 400. The data amount of the second modeling data may be larger than that of the first modeling data. According to still another embodiment, the first modeling data and the second modeling data may each be data corresponding to a part of the shape of the first object. The second modeling data may correspond to a shape obtained by simplifying the first object, and the first modeling data may correspond to a shape obtained by further simplifying the first object compared to simplification of the second modeling data.

In an embodiment, modeling data (e.g., first modeling data or second modeling data) may include a vertex and an index. The vertex may correspond to a set of points in a three-dimensional space. The index may correspond to information for connection between points in a three-dimensional space. The wearable device 200 may identify the shape of a virtual object in a three-dimensional space by using the vertex and the index. The shape of the virtual object may indicate a three-dimensional object configured by triangular surfaces. According to an embodiment, the first modeling data may include smaller number of vertexes or smaller number of indexes compared to that of the second modeling data.

According to an embodiment, in operation 805, the processor 230 may recognize that a state in which the first image data is received does not satisfy a designated condition. The designated condition in operation 805 may correspond to the designated condition described with reference to FIG. 6. According to another embodiment, in operation 807, in response to non-satisfaction of the designated condition by a state in which the first image data is received, the processor 230 may generate second image data including a first simplified object, based on the second modeling data. The processor 230 may generate the second image data by using the second modeling data having a larger data amount among the first modeling data and the second modeling data associated with the first object. In case that it is determined that the first object is required to be included in second image data when the second image data is generated, the wearable device 200 may use the second modeling data having a larger data amount among the first modeling data and the second modeling data associated with the first object. Therefore, the wearable device 200 may generate the first simplified object having a higher quality by using the second modeling data among the first modeling data and the second modeling data.

According to another embodiment, in operation 809, the processor 230 may control the display 240 to display the second image data.

According to yet another embodiment, by the operations illustrated in FIG. 8, the wearable device 200 may receive the second modeling data having a larger data amount compared to the first modeling data even after receiving the first modeling data, and accordingly, may display the first simplified object having a higher quality even in a state where the first image data is not normally received.

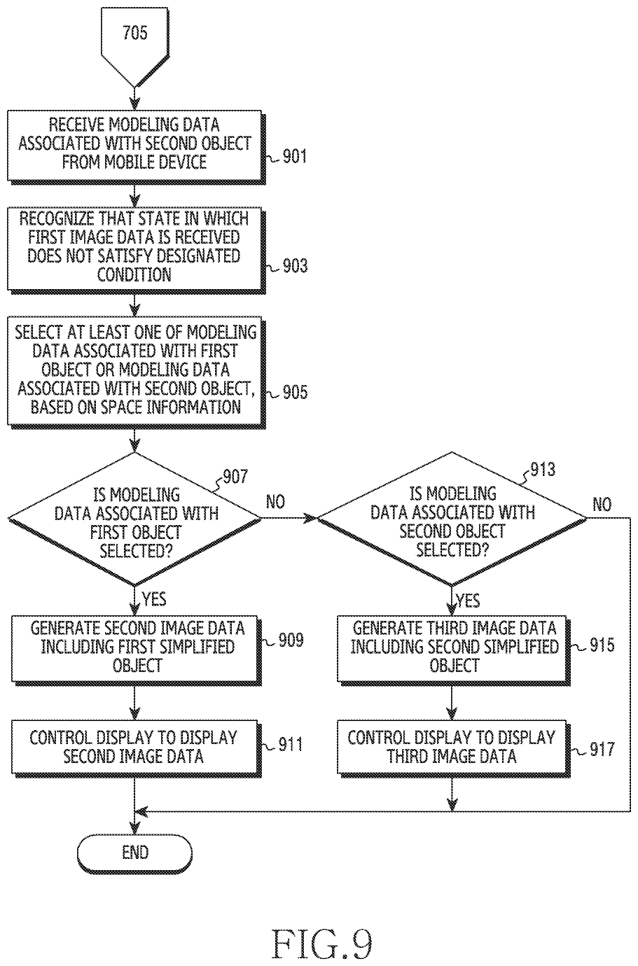

FIG. 9 is a flowchart illustrating an operation for generating second image data by further using space information by a wearable device according to an embodiment of the disclosure. Operations illustrated in FIG. 9 may be performed by a wearable device 200 or a processor 230 included in the wearable device 200.

In an embodiment, in operation 705 of FIG. 7, the processor 230 may receive modeling data associated with a first object from the mobile device 400. In another embodiment, in operation 901, the processor 230 may receive modeling data associated with a second object from the mobile device 400. The first object and the second object may be distinguished from each other. The first object may be an object located at a first point in a virtual space, and the second object may be an object located at a second point in the virtual space. As another example, the first object may be an arrow object, and the second object may be an icon object. In yet another embodiment, the processor 230 may store, in the memory 250, modeling data associated with the first object. In addition, the processor 230 may store, in the memory 250, modeling data associated with the second object.

According to an embodiment, in operation 903, the processor 230 may recognize that a state in which first image data is received does not satisfy a designated condition. The designated condition of operation 903 may correspond to the designated condition described with reference to FIG. 6.

According to another embodiment, in operation 905, the processor 230 may select at least one of the modeling data associated with the first object or the modeling data associated with the second object, based on space information. The processor 230 may select at least one of the modeling data associated with the first object or the modeling data associated with the second object by using space information obtained via the sensor 220. For example, the processor 230 may select an object located within a predetermined distance from the location of, in the virtual space, the wearable device 200, based on the location of the wearable device 200. As another example, the processor 230 may select an object located in front of the wearable device 200, based on the direction which the wearable device 200 faces. As another example, the processor 230 may select an object by considering the extent by which the location of the wearable device 200 has been changed or the extent by which the direction the wearable device 200 faces has been changed, with respect to a time point at which a state in which the first image data is received does not satisfy the designated condition.

According to yet another embodiment, in operation 907, in case that the processor 230 selects the modeling data associated with the first object, the processor 230 may, in operation 909, generate second image data including a first simplified object. The first simplified object may correspond to the first object. According to an embodiment, in operation 911, the processor 230 may control the display 240 to display the second image data.

According to an embodiment, in operation 913, in case that the processor 230 selects the modeling data associated with the second object, the processor 230 may, in operation 915, generate third image data including a second simplified object corresponding to the second object. According to an embodiment, in operation 917, the processor 230 may control the display 240 to display the third image data.

According to another embodiment, operations 907 to 917 of FIG. 9 have been described under the precondition that the processor 230 has selected at least one of the modeling data associated with the first object or the modeling data associated with the second object. However, this merely corresponds to one example, and various embodiments are possible. In case that the processor 230 has selected both of the modeling data associated with the first object or the modeling data associated with the second object, based on the space information, the processor 230 may render image data including both of the first simplified object and the second simplified object.

FIG. 10 is a flowchart illustrating an operation in which a mobile device transmits first image data and modeling data associated with a first object, based on space information received from a wearable device according to an embodiment of the disclosure. Operations illustrated in FIG. 10 may be performed by a mobile device 400 or a processor 430 included in the mobile device 400.

According to an embodiment, in operation 1001, the processor 430 may receive, from the wearable device 200 via the communication circuit 410, space information including at least one of location information corresponding to the location of the wearable device 200 or direction information corresponding to a direction in which the wearable device is oriented. Operation 1001 may correspond to operations 604 and 605 in FIG. 6.

According to another embodiment, in operation 1003, the processor 430 may generate first image data including a first object identified based on the space information among virtual objects in a virtual space. The processor 430 may transmit the first image data via the communication circuit 410 to allow the wearable device 200 to display the first image data. Operation 1003 may correspond to operations 606, 611, and 612 in FIG. 6.

According to yet another embodiment, in operation 1005, the processor 430 may transmit modeling data associated with the first object to the wearable device 200 via the communication circuit 410. Operation 1005 may correspond to operations 607 and 608 in FIG. 6.

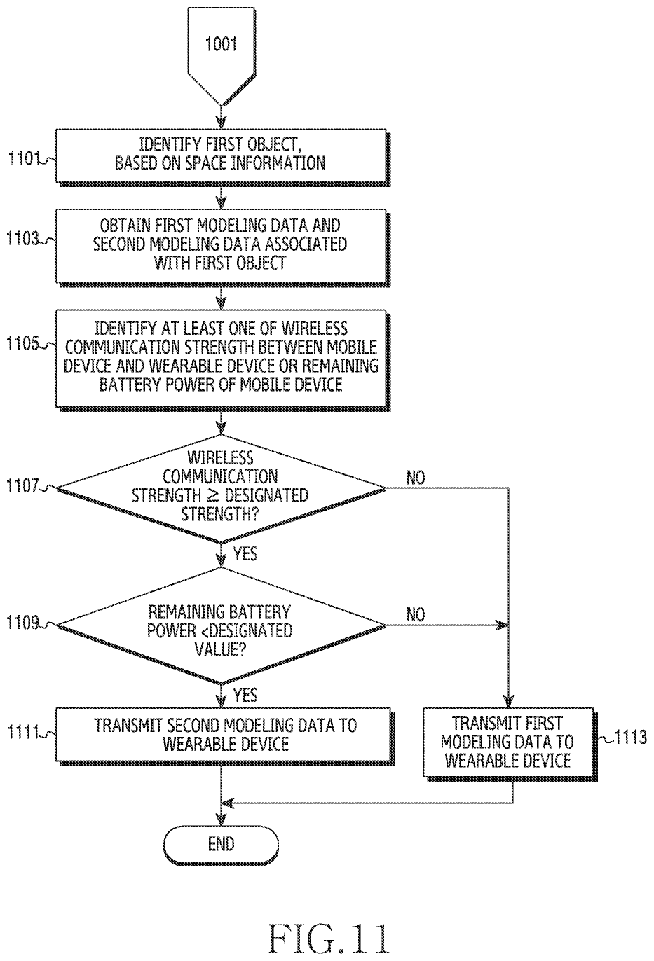

FIG. 11 is a flowchart illustrating an operation in which a mobile device selects and transmits, to a wearable device, one modeling data among first modeling data and second modeling data that have different data amounts and are associated with a first object according to an embodiment of the disclosure. Operations illustrated in FIG. 11 may be performed by a mobile device 400 or a processor 430 included in the mobile device 400.

In an embodiment, in operation 1101, the processor 430 may identify a first object, based on space information. Operation 1101 may correspond to operation 606 of FIG. 6.

In another embodiment, in operation 1103, the processor 430 may obtain first modeling data associated with the first object and second modeling data associated with the first object. The data amount of the first modeling data may be smaller than that of the second modeling data. For example, the processor 430 may obtain the first modeling data and the second modeling data stored in the memory 450, in response to identification of the first object. As another example, the processor 430 may obtain the first modeling data and the second modeling data by modeling the first object in response to identification of the first object. In yet another embodiment, the processor 430 may further obtain third modeling data that is associated with the first object and has a data amount larger than that of the second modeling data. In an embodiment, the processor 430 may further obtain bounding box data that is associated with the first object and has a data amount smaller than that of the first modeling data. A bounding box corresponds to the smallest hexahedron surrounding the first object and may be represented by two points in a three-dimensional space.

According to an embodiment, the processor 430 may determine the data amount of the first modeling data and the data amount of the second modeling data, based on the wireless communication bandwidth of the mobile device 400. In case that the short-range network bandwidth of the mobile device 400 is 10 Mbps, the processor 430 may determine 50 kbytes as the data amount of the first modeling data, 100 kbytes as the data amount of the second modeling data, and 200 kbytes as the data amount of the third modeling data. As another example, in case that the short-range network bandwidth of the mobile device 400 is 50 Mbps, the processor 430 may determine 200 kbytes as the data amount of the first modeling data, 500 kbytes as the data amount of the second modeling data, and 800 kbytes as the data amount of the third modeling data. The data amount of the first modeling data and the data amount of the second modeling data may be determined according to a hardware characteristic of the mobile device 400.

According to another embodiment, in operation 1105, the processor 430 may identify at least one of the wireless communication strength between the mobile device 400 and the wearable device 200 or the remaining battery power of the mobile device 400. For example, the wireless communication strength may include the Wi-Fi strength between the mobile device 400 and the wearable device 200. According to yet another embodiment, the processor 430 may select one of the first modeling data or the second modeling data, based on at least one of the wireless communication strength or the remaining battery power, and may transmit the selected data to the wearable device 200 via the communication circuit 410.

According to an embodiment, in operation 1107, the processor 430 may identify whether the wireless communication strength between the mobile device 400 and the wearable device 200 is equal to or greater than a designated strength.

According to another embodiment, in operation 1109, in response to the wireless communication strength being equal to or greater than the designated strength, the processor 430 may determine whether the remaining battery power of the mobile device 400 is smaller than a designated value.

According to yet another embodiment, in operation 1111, in response to the wireless communication strength being equal to or greater than the designated strength and the remaining battery power being smaller than the designated value, the processor 430 may transmit the second modeling data to the wearable device 200. In case that the wireless communication strength is equal to or greater than the designated strength, the processor 430 may transmit the second modeling data having a relatively large data amount to the wearable device 200.

According to an embodiment, in operation 1113, in response to the wireless communication strength being smaller than the designated strength, the processor 430 may transmit the first modeling data to the wearable device 200. In addition, in case that the wireless communication strength is equal to or greater than the designated strength and the remaining battery power of the mobile device 400 is equal to or larger than the designated value, the processor 430 may transmit the first modeling data to the wearable device 200.

According to another embodiment, even after transmitting the first modeling data associated with the first object to the wearable device 200 according to operation 1113, the processor 430 may transmit the second modeling data associated with the first object to the wearable device 200, based on at least one of the wireless communication strength or the remaining battery power. For example, after determining that the wireless communication strength is smaller than the designated strength and transmitting the first modeling data associated with the first object to the wearable device 200, the processor 430 may identify that the wireless communication strength has increased to be equal to or greater than the designated strength. In case that it is determined that the wireless communication strength is equal to or greater than the designated strength, the processor 430 may transmit the second modeling data having a data amount larger than that of the first modeling data to the wearable device 200.

According to yet another embodiment, FIG. 11 has been illustrated based on the processor 430 obtaining the first modeling data and the second modeling data in relation to the first object. However, this merely corresponds to one example, and various embodiments are possible. In case that the processor 430 obtains the first modeling data, the second modeling data, and the third modeling data in relation to the first object, the processor 430 may select one modeling data among the three-types of modeling data, based on the remaining battery amount of the mobile device 400, and transmit the selected modeling data to the wearable device 200.

According to an embodiment, operations 1107 to 1113 illustrated in FIG. 11 merely corresponds to one example, and various embodiments are possible. For example, the processor 430 may determine one data among the first modeling data and the second modeling data by considering the wireless communication strength rather than the remaining battery amount of the mobile device 400.

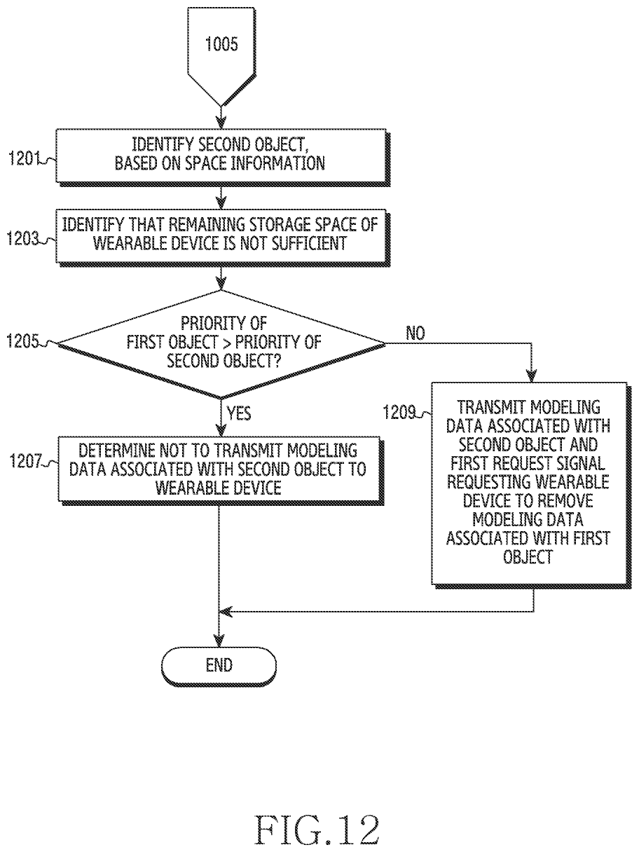

FIG. 12 is a flowchart illustrating an operation of considering the priorities of multiple objects by a mobile device according to an embodiment of the disclosure. Operations illustrated in FIG. 12 may be performed by a mobile device 400 or a processor 430 included in the mobile device 400.

In an embodiment, the memory 450 of the mobile device 400 may store at least one application and virtual objects associated with the at least one application. In another embodiment, the processor 430 may execute the at least one application. In still another embodiment, the processor 430 may identify at least one object among the virtual objects, based on space information while the at least one application is executed. For example, the processor 430 may identify at least one object, based on whether the distance between the wearable device 200 and the virtual objects in a virtual space is smaller than a first distance (e.g., 1 m or 2 m).

According to an embodiment, the processor 430 may identify at least one object, based on space information among virtual objects associated with at least one application (e.g., an application providing an augmented reality function), select at least a part of the at least one object, based on the remaining storage space of the wearable device 200, and transmit the selected same to the wearable device 200. There is a limit to the capacity of the memory 250 of the wearable device 200, and thus the processor 430 may not transmit modeling data associated with all virtual objects identified based on space information to the wearable device 200. With reference to FIG. 12, operations related to the contents of transmitting modeling data associated with some objects among virtual objects to the wearable device 200 will be described.

Referring to FIG. 12, in operation 1005, the processor 430 may transmit modeling data associated with a first object to the wearable device 200, and then in operation 1201, the processor 430 may identify a second object, based on space information. In case that a user is moving while wearing the wearable device 200, the mobile device 400 may identify the second object corresponding to a location different from that of the first object. According to an embodiment, the processor 430 may determine that modeling data associated with the second object is required to be transmitted to the wearable device 200, in response to identification of the second object.

According to an embodiment, in operation 1203, the processor 430 may identify that the remaining storage space of the wearable device 200 is not sufficient. The processor 430 may recognize that the wearable device 200 has an insufficient memory space to store the modeling data associated with the second object. For example, the processor 430 may obtain information on the remaining storage space of the memory 250 from the wearable device 200. As another example, the processor 430 may use the object allocator 433 illustrated in FIG. 5, to determine that the remaining storage space of the wearable device 200 is not sufficient.

According to another embodiment, in operation 1205, in case that the remaining storage space of the wearable device 200 is not sufficient, the processor 430 may determine the priorities between the first object and the second object.

According to still another embodiment, in case that the first object is associated with a first application and the second object is associated with a second application, the processor 430 may determine the priorities between the first object and the second object according to the priorities between the first application and the second application. The processor 430 may determine the priorities between the first application and the second application by considering the attributes of the first application and the second application. Alternatively, the processor 430 may determine the priorities between the first application and the second application according to previously designated priorities. Alternatively, in case that the first application is a navigation application showing the way to a user, and the second application is a game application, the processor 430 may determine that the priority of the first application is higher than that of the second application.

In an embodiment, in case that the first object and the second object are associated with the first application, the processor 430 may determine the priorities between the first object and the second object by further using space information. For example, the processor 430 may determine the priorities, based on whether a time for which the distance between the wearable device 200 and the virtual objects in the virtual space is smaller than a second distance (e.g., 0.5 m or 1 m) exceeds a predetermined time. The processor 430 may determine that an object having stayed around the wearable device 200 for a longer time among the first object and the second object has a higher priority. As another example, the processor 430 may determine the priorities, based on the volume of the virtual object and the speed at which the wearable device 200 moves. The processor 430 may determine that a virtual object having a small volume compared to the speed at which the wearable device 200 moves has a lower priority, by considering the ratio between the volume of the virtual object and the speed at which the wearable device 200 moves.

In another embodiment, in operation 1207, the processor 430 may determine not to transmit the modeling data associated with the second object to the wearable device 200, in response to determination that the first object has a priority higher than that of the second object.

In yet another embodiment, in operation 1209, the processor 430 may transmit, to the wearable device 200, the modeling data associated with the second object and a first request signal requesting the wearable device 200 to remove the modeling data associated with the first object, in response to determination that the first object has a priority lower than that of the second object. The processor 430 may request the wearable device 200 to remove the previously transmitted modeling data associated with the first object in order to allow the wearable device 200 to store the modeling data of the second object having a priority higher than that of the first object. In response to reception of the first request signal requesting removal of the modeling data associated with the first object, the processor 230 of the wearable device 200 may remove the modeling data stored in the memory 250.

According to an embodiment, in case that it is identified that the remaining storage space of the wearable device 200 is not sufficient in operation 1203, the processor 430 may transmit a part of the modeling data associated with the second object to the wearable device 200 unlike as illustrated FIG. 12. For example, the processor 430 may exclude an index among the index and a vertex included in the modeling data associated with the second object, and transmit the vertex to the wearable device 200.

According to another embodiment, in case that it is identified that the remaining storage space of the wearable device 200 is not sufficient in operation 1203, the processor 430 may transmit, to the wearable device 200, the modeling data associated with the second object and a second request signal requesting removal of a part of the modeling data associated with the first object unlike as illustrated FIG. 12. The processor 430 may request the wearable device 200 to remove a part of the previously transmitted modeling data associated with the first object in order to allow the wearable device 200 to store the modeling data of the second object having a priority higher than that of the first object. For example, the processor 430 may transmit, to the wearable device 200, the second request signal requesting the wearable device 200 to remove an index among the index and a vertex of the modeling data associated with the first object. According to an embodiment, in response to reception of the second request signal requesting removal of a part of the modeling data associated with the first object, the processor 230 of the wearable device 200 may remove the part of the modeling data stored in the memory 250.

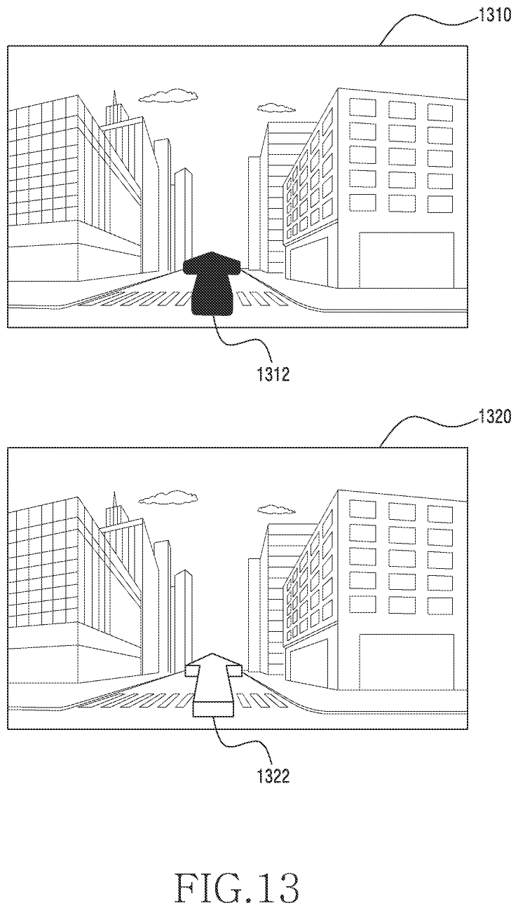

FIG. 13 illustrates an example of first image data and an example of second image data displayed by a wearable device according to an embodiment of the disclosure.

According to an embodiment, a mobile device 400 may generate first image data 1310 including a first object 1312. The wearable device 200 may display, on a display 240, the first image data 1310 received from the mobile device 400.

According to an embodiment, in response to non-satisfaction of a designated condition by a state in which the first image data 1310 is received from the mobile device 400, the wearable device 200 may generate second image data 1320 including a first simplified object 1322, based on modeling data. The wearable device 200 may display, on the display 240, the second image data 1320 rendered based on the modeling data.

According to another embodiment, the shape of the first simplified object 1322 included in the second image data 1320 may correspond to a part of the shape of the first object 1312 included in the first image data 1310. In an example, the first object 1312 has an arrow shape including a curved surface, and the first simplified object 1322 may have an arrow shape, the curved surface of which is partially replaced with a flat surface. As another example, the first object 1312 may be an arrow object configured by a surface including a color or a texture, and the first simplified object 1322 may be an arrow object configured by a surface not including a color or a texture. In FIG. 13, the first simplified object 1322 has been illustrated as a virtual object configured by an opaque surface, but this corresponds to one example, and various embodiments are possible. For example, the first simplified object 1322 may be an object configured by a line (e.g., a wire frame) without a surface.

According to embodiments of the disclosure, the wearable device 200 may receive an image (e.g., the first image data 1310) including an augmented reality content (e.g., the first object 1312) from the mobile device 400 via wireless communication, and display the image on the display 240, and even in a situation when wired/wireless communication between the wearable device 200 and the mobile device 400 becomes unstable, the wearable device 200 may generate, by itself, an image (e.g., the second image data 1320) including an augmented reality content (e.g., the first simplified object 1322). Therefore, there may occur an effect that, even in a situation where the wearable device 200 is unable to stably receive an image (e.g., the first image data 1310) from the mobile device 400, the wearable device 200 may generate an image (e.g., the second image data 1320) to provide an augmented reality content to a user.

A wearable device according to an embodiment may include: a communication circuit configured to transmit or receive data to or from a mobile device; a sensor; a display; and at least one processor electrically connected to the communication circuit, the sensor, and the display. The at least one processor may be configured to: obtain, via the sensor, space information including at least one of location information corresponding to a location of the wearable device or direction information corresponding to a direction in which the wearable device is oriented, and transmit the space information to the mobile device via the communication circuit; in response to satisfaction of a designated condition by a state in which first image data is received from the mobile device via the communication circuit, display, on the display, the first image data including a first object identified based on the space information; receive modeling data associated with the first object from the mobile device via the communication circuit; and in response to non-satisfaction of the designated condition by a state in which the first image data is received from the mobile device via the communication circuit, generate second image data, based on the modeling data, and display the second image data on the display, the second image data including a first simplified object corresponding to the first object.

In the wearable device according to an embodiment, the designated condition may include at least one of a wireless communication strength between the mobile device and the wearable device or a reception speed of the first image data.

In the wearable device according to another embodiment, the at least one processor may be configured to: receive first modeling data associated with the first object from the mobile device; receive second modeling data associated with the first object from the mobile device, a data amount of the second modeling data being greater than that of the first modeling data; and after the reception of the first modeling data and the second modeling data, in response to non-satisfaction of the designated condition by a state in which the first image data is received, generate the second image data including the first simplified object, based on the second modeling data.

The wearable device according to yet another embodiment may further include a memory electrically connected to the at least one processor. The at least one processor may be configured to: store, in the memory, the modeling data associated with the first object and received from the mobile device; receive modeling data associated with a second object from the mobile device via the communication circuit, the second object being distinguished from the first object; and store the modeling data associated with the second object in the memory.

In the wearable device according to an embodiment, the at least one processor may be configured to, after the reception of the modeling data associated with the first object and the modeling data associated with the second object, in response to non-satisfaction of the designated condition by a state in which the first image data is received: select at least one of the modeling data associated with the first object or the modeling data associated with the second object, based on the space information; in response to selection of the modeling data associated with the first object, generate the second image data including the first simplified object; and control the display to display the second image data.

The wearable device according to another embodiment may further include a memory configured to store the modeling data associated with the first object. The at least one processor may be configured to, in response to reception of, from the mobile device, a request signal requesting removal of at least a part of the modeling data associated with the first object, remove the at least a part of the modeling data associated with the first object from the memory.

In the wearable device according to still another embodiment, a shape of the first simplified object may correspond to a part of a shape of the first object.

In the wearable device according to an embodiment, the sensor may include at least one of an acceleration sensor, a gyro sensor, a geomagnetic sensor, or an image sensor.

A mobile device according to an embodiment may include: a communication circuit configured to transmit or receive data to or from a wearable device; and at least one processor electrically connected to the communication circuit. The at least one processor may be configured to: receive, from the wearable device via the communication circuit, space information including at least one of location information corresponding to a location of the wearable device or direction information corresponding to a direction in which the wearable device is oriented; generate first image data including a first object identified based on the space information among virtual objects in a virtual space, and transmit the first image data via the communication circuit to allow the wearable device to display the first image data; and transmit modeling data associated with the first object to the wearable device via the communication circuit, wherein the modeling data is used to allow the wearable device to display a first simplified object corresponding to the first object.

In the mobile device according to another embodiment, the at least one processor may be configured to: obtain first modeling data and second modeling data, which are associated with the first object, a data amount of the second modeling data being greater than that of the first modeling data; identify at least one of a wireless communication strength between the mobile device and the wearable device, or a remaining battery power of the mobile device; select one of the first modeling data or the second modeling data, based on at least one of the wireless communication strength or the remaining battery power; and transmit the selected modeling data to the wearable device via the communication circuit.

In the mobile device according to yet another embodiment, the at least one processor may be configured to: determine whether the wireless communication strength is equal to or greater than a designated strength; and in response to the wireless communication strength being smaller than the designated strength, transmit the first modeling data to the wearable device.

In the mobile device according to an embodiment, the at least one processor may be configured to: in response to the wireless communication strength being equal to or greater than the designated strength and the remaining battery power being equal to or greater than a designated value, transmit the first modeling data to the wearable device; and in response to the wireless communication strength being equal to or greater than the designated strength and the remaining battery power being smaller than the designated value, transmit the second modeling data to the wearable device.

In the mobile device according to another embodiment, the at least one processor may be configured to determine a data amount of the first modeling data and a data amount of the second modeling data based on a wireless communication bandwidth of the mobile device.

The mobile device according to still another embodiment may further include a memory configured to store at least one application and the virtual objects associated with the at least one application. The at least one processor may be configured to: execute the at least one application; identify at least one object among the virtual objects, based on the space information while the at least one application is executed; and select at least a part of the at least one object, based on a remaining storage space of the wearable device.

In the mobile device according to an embodiment, the at least one processor may be configured to identify the at least one object, based on whether a distance between the wearable device and the virtual objects in the virtual space is smaller than a first distance.

In the mobile device according to another embodiment, the at least one processor may be configured to: after the transmission of the modeling data associated with the first object to the wearable device, identify a second object distinguished from the first object, based on the space information; in case that the remaining storage space of the wearable device is not sufficient, determine priorities between the first object and the second object; in response to determination that the priority of the first object is higher than that of the second object, determine not to transmit modeling data associated with the second object to the wearable device; and in response to determination that the priority of the first object is lower than that of the second object, transmit the modeling data associated with the second object and a first request signal requesting the wearable device to remove the modeling data associated with the first object.

In the mobile device according to still another embodiment, the first object may be associated with a first application, the second object may be associated with a second application, and the at least one processor may be configured to determine the priorities between the first object and the second object according to priorities between the first application and the second application.

In the mobile device according to an embodiment, the first object and the second object may be associated with a first application, and the at least one processor may be configured to determine the priorities between the first object and the second object by further using the space information.

In the mobile device according to another embodiment, the at least one processor may be configured to: after the transmission of the modeling data associated with the first object to the wearable device, identify a second object distinguished from the first object, based on the space information; and in case that the remaining storage space of the wearable device is not sufficient, transmit a part of modeling data associated with the second object to the wearable device.

In the mobile device according to yet another embodiment, the at least one processor may be configured to: after the transmission of the modeling data associated with the first object to the wearable device, identify a second object distinguished from the first object, based on the space information; and in case that the remaining storage space of the wearable device is not sufficient, transmit modeling data associated with the second object and a second request signal requesting removal of a part of the modeling data associated with the first object.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device comprising:
a communication circuit configured to transmit or receive data to or from a mobile device;
a sensor;
a display; and
at least one processor electrically connected to the communication circuit, the sensor, and the display,
wherein the at least one processor is configured to:
obtain, via the sensor, space information including at least one of location information corresponding to a location of the wearable device or direction information corresponding to a direction in which the wearable device is oriented, and transmit the space information to the mobile device via the communication circuit,
in response to satisfaction of a designated condition by a state in which first image data is received from the mobile device via the communication circuit, display, on the display, the first image data including a first object identified based on the space information,
receive modeling data associated with the first object from the mobile device via the communication circuit, and
in response to non-satisfaction of the designated condition by a state in which the first image data is received from the mobile device via the communication circuit, generate second image data, based on the modeling data, and display the second image data on the display, the second image data including a first simplified object corresponding to the first object.

2. The wearable device of claim 1, wherein the designated condition comprises at least one of a wireless communication strength between the mobile device and the wearable device, or a reception speed of the first image data.

3. The wearable device of claim 1, wherein the at least one processor is further configured to:
receive first modeling data associated with the first object from the mobile device,
receive second modeling data associated with the first object from the mobile device, a data amount of the second modeling data being greater than that of the first modeling data, and
after the reception of the first modeling data and the second modeling data, in response to non-satisfaction of the designated condition by a state in which the first image data is received, generate the second image data including the first simplified object, based on the second modeling data.

4. The wearable device of claim 1, further comprising:
a memory electrically connected to the at least one processor,
wherein the at least one processor is further configured to:
store, in the memory, the modeling data associated with the first object and received from the mobile device,
receive modeling data associated with a second object from the mobile device via the communication circuit, the second object being distinguished from the first object, and
store the modeling data associated with the second object in the memory.

5. The wearable device of claim 4, wherein the at least one processor is further configured to, after the reception of the modeling data associated with the first object and the modeling data associated with the second object, in response to non-satisfaction of the designated condition by a state in which the first image data is received:
select at least one of the modeling data associated with the first object or the modeling data associated with the second object, based on the space information,
in response to selection of the modeling data associated with the first object, generate the second image data including the first simplified object, and
control the display to display the second image data.

6. The wearable device of claim 1, further comprising:
a memory configured to store the modeling data associated with the first object,
wherein the at least one processor is further configured to, in response to reception of, from the mobile device, a request signal requesting removal of at least a part of the modeling data associated with the first object, remove the at least a part of the modeling data associated with the first object from the memory.

7. The wearable device of claim 1, wherein a shape of the first simplified object corresponds to a part of a shape of the first object.

8. The wearable device of claim 1, wherein the sensor comprises at least one of an acceleration sensor, a gyro sensor, a geomagnetic sensor, or an image sensor.

9. A mobile device comprising:
a communication circuit configured to transmit or receive data to or from a wearable device; and
at least one processor electrically connected to the communication circuit,
wherein the at least one processor is configured to:
receive, from the wearable device via the communication circuit, space information including at least one of location information corresponding to a location of the wearable device or direction information corresponding to a direction in which the wearable device is oriented,
generate first image data including a first object identified based on the space information among virtual objects in a virtual space, and transmit the first image data via the communication circuit to allow the wearable device to display the first image data, and
transmit modeling data associated with the first object to the wearable device via the communication circuit, and
wherein the modeling data is used to allow the wearable device to display a first simplified object corresponding to the first object.

10. The mobile device of claim 9, wherein the at least one processor is further configured to:
obtain first modeling data and second modeling data, which are associated with the first object, a data amount of the second modeling data being greater than that of the first modeling data,
identify at least one of a wireless communication strength between the mobile device and the wearable device, or a remaining battery power of the mobile device,
select one of the first modeling data or the second modeling data, based on at least one of the wireless communication strength or the remaining battery power, and
transmit the selected modeling data to the wearable device via the communication circuit.

11. The mobile device of claim 10, wherein the at least one processor is further configured to:
determine whether the wireless communication strength is equal to or greater than a designated strength, and
in response to the wireless communication strength being smaller than the designated strength, transmit the first modeling data to the wearable device.

12. The mobile device of claim 11, wherein the at least one processor is further configured to:
in response to the wireless communication strength being equal to or greater than the designated strength and the remaining battery power being equal to or greater than a designated value, transmit the first modeling data to the wearable device, and
in response to the wireless communication strength being equal to or greater than the designated strength and the remaining battery power being smaller than the designated value, transmit the second modeling data to the wearable device.

13. The mobile device of claim 10, wherein the at least one processor is further configured to determine a data amount of the first modeling data and a data amount of the second modeling data, based on a wireless communication bandwidth of the mobile device.

14. The mobile device of claim 9, further comprising:
a memory configured to store at least one application and the virtual objects associated with the at least one application,
wherein the at least one processor is further configured to:
execute the at least one application,
identify at least one object among the virtual objects, based on the space information while the at least one application is executed, and
select at least a part of the at least one object, based on a remaining storage space of the wearable device.

15. The mobile device of claim 14, wherein the at least one processor is further configured to identify the at least one object, based on whether a distance between the wearable device and the virtual objects in the virtual space is smaller than a first distance.

16. The mobile device of claim 14, wherein the at least one processor is further configured to:
after the transmission of the modeling data associated with the first object to the wearable device, identify a second object distinguished from the first object, based on the space information,
in case that the remaining storage space of the wearable device is not sufficient, determine priorities between the first object and the second object,
in response to determination that the priority of the first object is higher than that of the second object, determine not to transmit modeling data associated with the second object to the wearable device, and
in response to determination that the priority of the first object is lower than that of the second object, transmit the modeling data associated with the second object and a first request signal requesting the wearable device to remove the modeling data associated with the first object.

17. The mobile device of claim 16,
wherein the first object is associated with a first application,
wherein the second object is associated with a second application, and
wherein the at least one processor is configured to determine the priorities between the first object and the second object according to priorities between the first application and the second application.

18. The mobile device of claim 16,
wherein the first object and the second object are associated with a first application, and
wherein the at least one processor is configured to determine the priorities between the first object and the second object by further using the space information.

19. The mobile device of claim 14, wherein the at least one processor is further configured to:
after the transmission of the modeling data associated with the first object to the wearable device, identify a second object distinguished from the first object, based on the space information, and
in case that the remaining storage space of the wearable device is not sufficient, transmit a part of modeling data associated with the second object to the wearable device.

20. The mobile device of claim 14, wherein the at least one processor is further configured to:
after the transmission of the modeling data associated with the first object to the wearable device, identify a second object distinguished from the first object, based on the space information, and
in case that the remaining storage space of the wearable device is not sufficient, transmit modeling data associated with the second object and a second request signal requesting removal of a part of the modeling data associated with the first object.
